(19) United States
(12) Patent Application Publication
(10) Pub. No.: US 2024/0211844 A1
(43) Pub. Date: Jun. 27, 2024

(54) SYSTEMS AND METHODS FOR PRESCRIPTIVE REPORTING BASED ON METADATA TRIGGERS

(71) Applicant: Honeywell International Inc., Charlotte, NC (US)

(72) Inventors: Ankit SINGH, Apex, NC (US); Matthew CHANG, Malvern, PA (US)

(21) Appl. No.: 18/069,242

(22) Filed: Dec. 21, 2022

(51) Int. Cl. G06Q 10/0639

(52) U.S. Cl. CPC G06Q 10/06395

(57) ABSTRACT

A computing system including a processor and a memory configured to: receive incoming data related to one or more quality assurance business processes; analyze the incoming data to determine data meeting flagging criteria for flagging the incoming data as flagged data, wherein the data meeting flagging criteria indicates that additional context is necessary with respect to the flagged data the incoming data includes a number of quality assurance reports generated within a given period and the flagging criteria includes a threshold number of quality assurance reports generated within the given period such that the incoming data is flagged if the number of reports generated within the given period exceeds the threshold; and automatically generate a context report based on the flagged data, wherein the context report includes, at least, the flagged data and context data that indicates specific flagging criteria of the flagged data.

### TECHNICAL FIELD

The present disclosure relates generally to report generation, and more specifically, to automatic, prescriptive report generation based on metadata tags associated with received data.

### BACKGROUND

Business intelligence reports are critical tools of an organization's reporting because they may provide critical context for operations and administration of the organization's functions. Business intelligence reports can be used to increase efficiency by identifying and understanding root causes of mistakes, delays, and misappropriation of resources in a supply chain or other business operation. Business intelligence reporting can be even more critical in certain industries, such as the pharmaceutical industry, where delays in distribution of strictly-regulated products with exacting expiration times can lead to significant financial losses.

In spite of the potential for large losses, business intelligence tools, which are used to identify and explain inefficiencies, currently lack a means for automatic, contextual reporting. Many facets of operations may be tracked and reported using accurate data trackers, but this data requires painstaking review and contextualization by human operators, notwithstanding that some of these data gathering and analysis processes could be automated. Accordingly, systems and methods for prescriptive reporting based on metadata triggers is needed.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

In one embodiment, a computing system comprises: a processor configured for executing one or more processes based on machine-readable instructions; and a memory storing one or more machine readable instructions, including a rules engine, that when executed by the processor cause the computing system to: receive incoming data related to one or more quality assurance business processes; analyze the incoming data to determine data meeting flagging criteria for flagging the incoming data as flagged data, wherein the data meeting flagging criteria indicates that additional context is necessary with respect to the flagged data the incoming data includes a number of quality assurance reports generated within a given period and the flagging criteria includes a threshold number of quality assurance reports generated within the given period such that the incoming data is flagged if the number of reports generated within the given period exceeds the threshold; and automatically generate a context report based on the flagged data, wherein the context report includes, at least, the flagged data and context data that indicates specific flagging criteria of the flagged data.

In another embodiment, a method of receiving descriptive data that describes raw report generation data based on information about the raw report generation data includes generating descriptive data related to one or more products or business processes related to patient information, patient treatment, pharmaceutical business processes, or pharmaceutical products; storing the descriptive data in one or more databases as raw report generation data for the generation of one or more reports related to patient information, patient treatment, pharmaceutical business processes, or pharmaceutical products; migrating the raw report generation data to a products database for inclusion in a current report related to patient information, patient treatment, pharmaceutical business processes, or pharmaceutical products; generating one or more flag criteria for flagging raw report generation data; flagging raw report generation data that meets one or more of the flag criteria as flagged report generation data; requesting descriptive information from the one or more databases based on the flagged report generation data; and receiving descriptive information related to the flagged report generation data.

In yet another embodiment, a method of automatically generating one or more business intelligence reports includes migrating raw report generation data from one or more databases storing descriptive data to a products database for inclusion in a current report related to patient information, patient treatment, pharmaceutical business processes, or pharmaceutical products; generating one or more flag criteria for flagging raw report generation data; flagging raw report generation data that meets one or more of the flag criteria as flagged report generation data; requesting descriptive information from the one or more databases based on the flagged report generation data; receiving descriptive information related to the flagged report generation data; and compiling the received descriptive information related to the flagged report generation data into a report for presentation to a user in a form of a prescriptive report.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Embodiments of the disclosure will now be described, by way of example only, with reference to the accompanying drawings in which:

FIG. 1 illustrates an exemplary computer environment for prescriptive reporting based on metadata triggers, according to one or more embodiments shown and described herein.

FIG. 2 illustrates an exemplary logistical operation that may benefit from prescriptive reporting.

FIG. 3 illustrates an exemplary system diagram for prescriptive reporting based on metadata triggers.

FIG. 4 illustrates an exemplary computing system for prescriptive reporting based on metadata triggers.

FIG. 5 illustrates an exemplary chart including data having met one or more metadata triggers.

FIG. 6 illustrates another exemplary chart including data having met one or more metadata triggers.

FIG. 7 illustrates a method for generating one or more prescriptive report based on metadata triggers.

FIG. 8 illustrates a second method for generating one or more prescriptive report based on metadata triggers.

### DETAILED DESCRIPTION

Automation of report generation or of aspects of reports could save an organization man hours, increasing organizational efficiency. However, generation of reports requires significant contextual understanding about how an organization functions. For example, a pharmaceutical company with multiple manufacturers generating scores of products in dozens of different countries may experience great difficulty reporting on all logistical delays and other production inefficiencies as differences in reporting criteria, workflow, reporting chains, and other business structures may result in significant confusion. However, companies may keep one or more central repositories of data associated with all logistical operations, providing access to all or nearly all operations data. With such global access, enlightening reports could be automatically drafted given the proper connections, or rules, connecting the information with the reporting thereof. Accordingly, systems and methods for prescriptive reporting based on metadata triggers may be required.

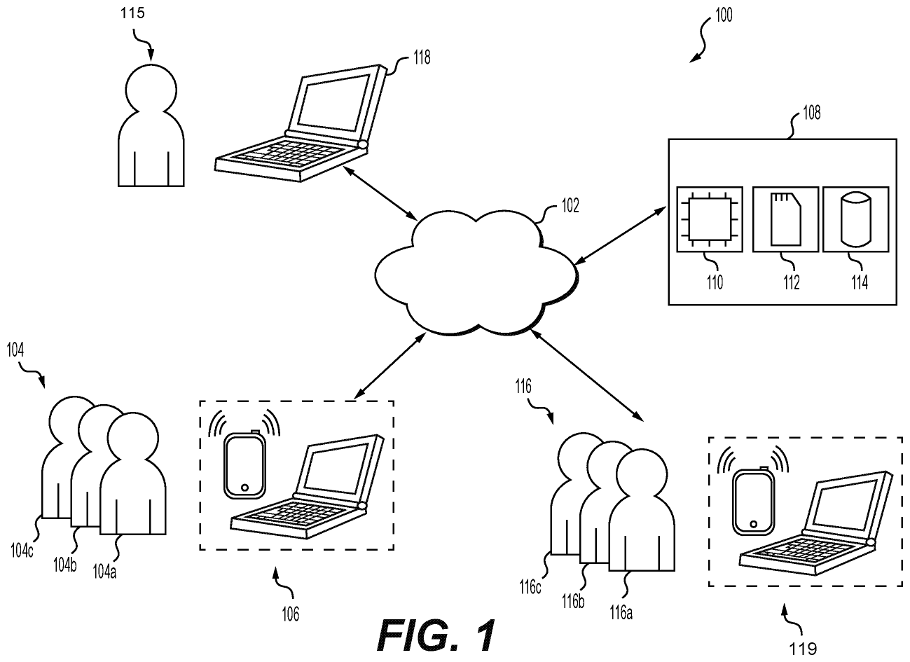

Referring to FIG. 1, a system 100 for context-based prescriptive reporting is shown. The system 100 may include a plurality of nodes comprising one or more processing devices (e.g., personal computers, computer networks, personal devices, device networks, etc.) communicatively coupled to a network 102, which may be a cloud-based network. One or more users may be connected to the network 102. For example, an admin 115 may connect to the network through an admin device 118. In some embodiments, user profiles associated with one or more users may be grouped together based on some common factor and the user profiles may be granted one or more permissions for accessing the network 102 with an identity and access management system. For example, the user profiles may grouped by department within an organization (e.g., sales, operations, accounting, etc.) A first department 104 may include one or more users 104a, 104b, 104c, etc. who may access the network 102 via computing devices 106 and a second department 116 may include one or more users 116a, 116b, 116c, etc. who may access the network 102 via computing devices 119. In some embodiments, one or more firewalls may exist between the various departments such that data accessible by one department is not necessarily accessible by members of another department. While two departments are shown, it is to be understood that the organization can include any number of departments. The departments may have titles that allude to a function of the department within the organization and the individual users may be grouped into their department based on the same. For example, a quality assurance department, accounting, operations, sales, supply, administration, research and development, human resources, etc. may include individual members performing such functions. A document management server 108 may be communicatively coupled to the network 102. The document management server 108 may comprise one or more processing devices 110, one or more memory devices 112, and one or more databases 114.

The network 102 may be used to transmit data from the various data processing devices to the server (e.g., a computer of any appropriate configuration) in an appropriate manner. For instance, the data processing device(s) and the server may communicate over a local area computer network (LAN) or a public computer network (e.g., the Internet). In some embodiments, the network 102 may be a private LAN and may be separated from the public Internet by, for example, a firewall. The information associated with a context-based search may be transmitted from the server to one or more of the nodes in any appropriate manner. For instance, the server and a node (e.g., a personal computer; a desktop computer; a laptop computer; a “dumb” terminal) at any location connected to the network may communicate over a computer network, such as a public computer network (e.g., the Internet). A web application may be used to view search results as well.

The one or more processors 110 may communicatively couple with the one or more memory devices to perform one or more of the computer-based methods described herein. The DMS 108 may enable users to manage one or more types of files such as, for example, text-based files, charts, presentations, images, videos, sounds, and other types of files. In some embodiments, the files may include one or more portions of one or more Annual Product Quality Reviews (APQR). An APQR may be a document that fulfills an annual, regulatory requirement for pharmaceutical and life sciences companies. The regulatory requirement may be assigned by one or more external organizations, such as, for example, the United States Food and Drug Administration (FDA) or other organizations. It may be a regulatory requirement for some companies to submit APQRs for a given product line, for a business sector, for the business as a whole, and/or for one or more other purposes. The APQR may store information which may assist a pharmaceutical and/or life sciences company to revalidate its various processes, products, and other facets of its operation. The APQR of one year may be built on previous APQRs and tracking APQRs and their contents over multiple generations may help a company assess operational and administrative changes required in product specifications, manufacturing instructions, control procedures, and with other products and processes.

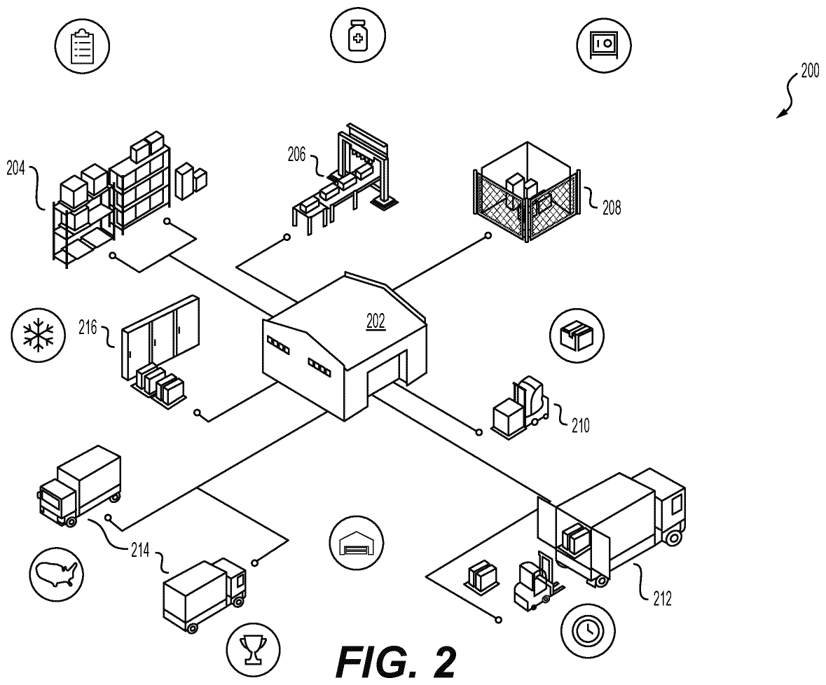

Referring to FIG. 2, an exemplary logistical operation 200 is shown. The logistical operation includes an exemplary warehouse 202, which may be configured to operate, at least in part, based on one or more automated or semi-automated procedures carried out by a warehouse management system (WMS) 204. The warehouse 202 may be an automated or semi-automated environment and may include one or more automation technologies such as carousels, a-frames, and sorting systems. The WMS 204 may generally track inventory levels and optimize workflow and storage. The logistical operation 200 may be configured such that products are shipped to one or more distributors 206. Further, in some embodiments, the products created, stored, and shipped with the logistical operation 200 may be controlled substances and may require storage in one or more high-security areas 208. The high-security areas may have access controls and systems generating data regarding the controlled substances may be generated, stored, and transmitted subject to one or more sensitivity levels or access controls. The logistical operation 200 may include one or more automated, semi-automated, or manually operated pickers 210 and products may be shipped, for example, using one or more trucks 212. In some embodiments, the trucks 212 may part of a distribution network 214, which may distribute one or more products (e.g., therapeutic drugs, vaccines, etc.) In some embodiments, the products must be stored in refrigerated storage 216 to meet one or more product requirements. Products stored in refrigerated storage 216 may require insulated and/or refrigerated transportation and may be monitored during storage for temperature and other criteria. The various portions and steps of the logistical operation 200 can be automatically and/or manually tracked, for example using one or more sensors or input from personnel associated with the logistical operation (who could be users of the network 102, for example). The data generated in carrying out the day-to-day operations of the logistical operation 200 is exemplary data which could be used in the systems and methods of prescriptive reporting based on one or more metadata triggers as described herein. The data generated (e.g., number of units (e.g., pills, vials, etc.) created, number of units shipped, number of units destroyed, etc.) will include metadata associated with the data itself which can be used to provide relevant context about all facets of the

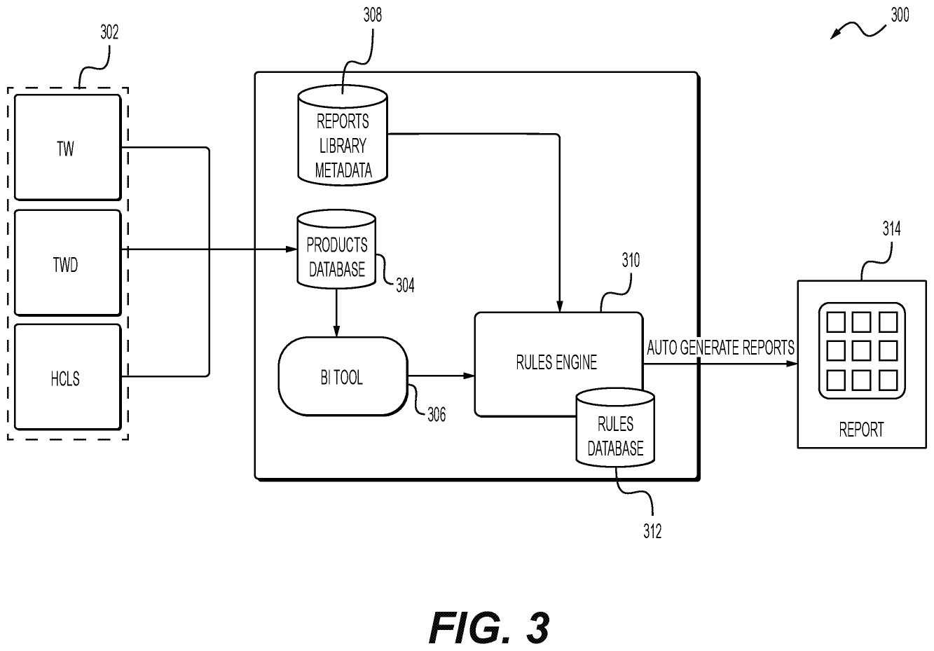

Referring to FIG. 3, a system diagram 300 for prescriptive reporting based on one or more metadata triggers is shown. The system 300 may include a quality management system (QMS) module 302, a products database 304, a business intelligence (BI) tool 306, a reports library 308 including metadata, a rules engine 310 including one or more rules in a rules database 312, which may be used to automatically generate one or more reports 314.

The QMS module 302 may be configured to connect to one or more nodes in the network to receive one or more reports or other data from the connected node and may allow users to access data from any of the other various nodes depending on permissions of the user. In some embodiments, the QMS module 302 may populate products data (e.g., data from the logistical operation 200) to the products database 304. In some embodiments, the relevant systems and/or databases for providing data may be automatically selected. The automatically selected databases may be selected based on one or more rules in the BI tool 306 and/or the rules engine 310. The QMS module 302 may include one or more caches or containers for storing corporate documents and other content. In embodiments, a content type may define how the content is stored in the QMS module 302 (e.g., with what metadata the content is stored). For example, business logic and methods, database structure, definitions (e.g., schema, field, table, etc.) and associated content of different content types may be stored in different manners. Business logic and the methods of the module may be configured to act based on particular content items having been stored in the database (e.g., in the case of a particular metadata). For example, content with a characterization of “corporate” or characterized as belonging to a particular department (e.g., quality review, testing, sales, corporate, etc.) may relate to users from the respective department and may be configured to apply rules to data based on a user's profile as being a member of a respective department.

The business intelligence tool 306 may be used to access the products databases 304 and may provide an interface for developers and others to generate reports, manage, and mine the data stored in the products database 304. For example, the products database 304 may be queriable using the business intelligence tool 306.

The products database 304 may store data tuned for expected access patterns based on access of the one or more users. The information on the products database 304 may be indexed, pre-aggregated, restricted access, allow ad-hoc reporting, etc. The products database 304 may be managed using a database management system (DMS) (not shown).

The business intelligence tool 306 may include one or more subtools or components used to analyze data and present information to business users (e.g., the users 104, the users 116, etc.) include a suite of technologies that can be built into a BI architecture—for example, ad hoc query, data mining and online analytical processing, or OLAP, software. In addition, the growing adoption of self-service BI tools enables business analysts and managers to run queries themselves instead of relying on the members of a BI team to do that for them. The BI software may also include data visualization tools that can be used to create graphical representations of data, in the form of charts, graphs and other types of visualizations designed to illustrate trends, patterns and outlier elements in data sets. The BI tool 306 may provide direct access to the products database to customers so that the customer can run their own custom analytics/reporting using the BI tool 306.

The rules engine 310 may administrate one or more report generation rules as described in greater detail herein. For example, the rules engine 310 may generate one or more reports regarding quality events. Quality events may include failures of a process and/or a product to meet specifications, protocols, timelines, customer expectations, or requirements. A quality event could include, for example, the expiration of one or more batches of a particular product, which expired before they were classified as “ready to ship” from a manufacturing or storage location. The prescriptive reporting may provide additional context regarding the cause of the quality event in order to better understand the quality event and/or its root causes. In some embodiments, the rules engine 310 may generate reports, report shells, charts, graphs, and other informational outputs based on inputs from the business intelligence tool 306 and the reports library 308. The rules engine 310 may store one or more rules for generating information outputs from the business intelligence tool inputs 306 in a rules database 312, which may be communicatively coupled to the rules engine 310. Portions of the rules database 312 may be stored locally and/or remotely with the other components of the system (e.g., in a cloud network, etc.)

The reports library 308 may be a collection of reports generated using the system 300 by, for example, the users of the system 300 or by the system itself through automatic report generation. The reports library 308 may store one or more report templates, report sections, report charts, graphs, and other information (e.g., figures, icons, etc.) for use in the creation of one or more subsequent reports or portions there. In some embodiments, the reports library may include one or more classified, private, or selectively accessible folders for containing classified or selectively-accessible information. Such selectively-accessible information may be accessible based on a user's permissions and access within the system. In some embodiments, portions of a report may include one or more links to other portions of a report that may link to one or more documents stored in the reports library 308. The reports library 308 may include metadata which may include information such as a list of authors and/or editors, a report description, data source, creation and/or edit date(s), indication of whether a report is complete, published, accessible, etc. and other metadata associated with a report. The reports library 308 or portions thereof may be made available along with a released product such that users can access the relevant portions of a report when they purchase or otherwise have access to a released product. Generated reports may automatically populate the reports library 308 and these reports can be configured to run on-demand or scheduled with their own set of parameters.

The report 314 may include one or more sections which are auto generated based on output of the rules engine 310 from the inputs of the BI tool 306 and the reports library 308. The report may be viewable in multiple formats (e.g., .doc, .pdf, .csv, .xcl, etc.) The report 314 may be viewable on multiple devices simultaneously and accessible depending on a user's access and identity (as determined by, for example, an identity and access module). The report 314 may be associated with one or more publish and/or export capabilities which may allow a user to publish and/or export a report to an external organization. Once a report 314 is generated it may be reviewed by an approver, for example, and may be saved along with metadata indicating it is an approved report, for example, in the reports library 308 for use as a shell or template or future reports.

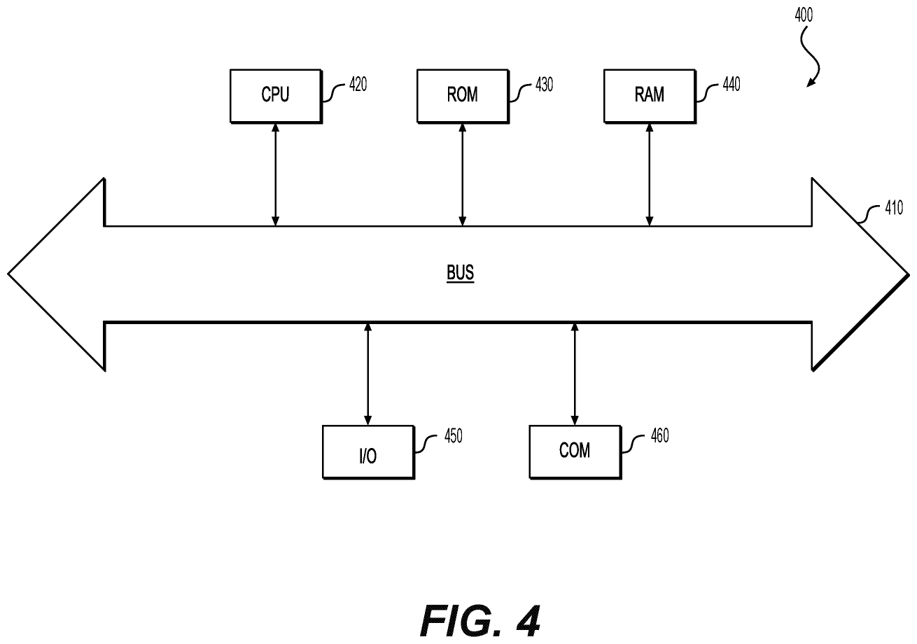

FIG. 4 is a simplified functional block diagram of a computing system 400 that may be configured for carrying out one or more of the steps, programs, and/or executing techniques described herein, according to exemplary embodiments of the present disclosure. Specifically, in one embodiment, any of the modules of the system 100 may be an assembly of software and/or hardware including, for example, a data communication interface 460 for packet data communication. The platform may also include a central processing unit (“CPU”) 420, in the form of one or more processors, for executing program instructions. The platform may include an internal communication bus 410, program storage, and data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

Any suitable system infrastructure may be put into place to allow for the assessment of models monitoring devices. FIG. 4 and the following discussion provide a brief, general description of one example of a suitable computing environment in which certain embodiments and aspects thereof the present disclosure may be implemented. In one embodiment, any of the disclosed systems, methods, and/or graphical user interfaces may be executed by or implemented by a computing system consistent with or similar to that depicted in FIG. 4. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

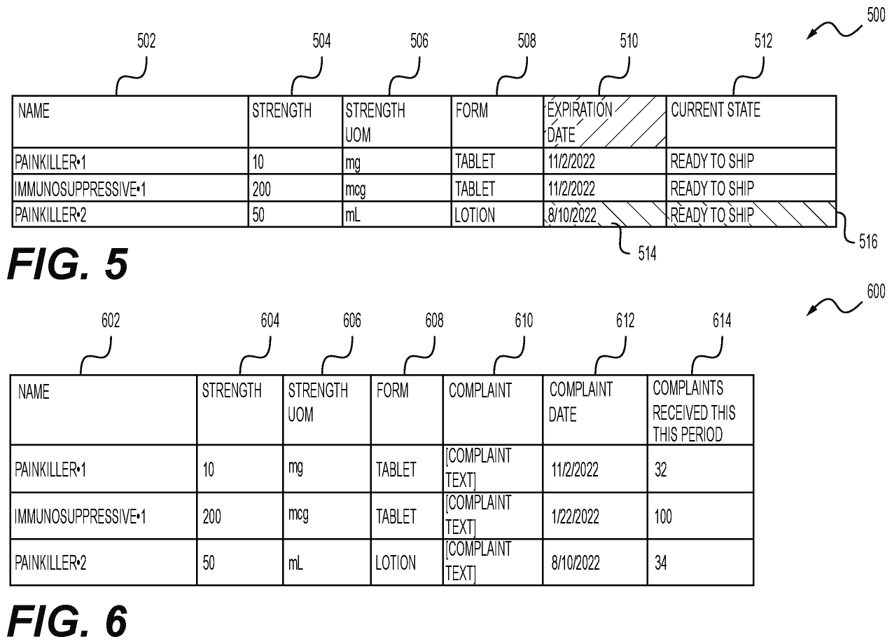

FIG. 5 depicts an exemplary chart 500 including quality data displayed in multiple columns including information about various products. The information includes: a product name 502, a product strength 504, a strength unit of measurement 506, a format 508, an expiration date 510, and a current state 512 with respect to the products status for shipping (e.g., “ready to ship,” etc.) The name 502 may refer to, for example, a particular product (e.g., a pharmaceutical product, a vaccine, etc.) which may identify the product from others and the various other columns may provide additional information about the product. Referring to the expiration date 510 column, this information may be input manually and/or automatically (e.g., using a warehouse management system (WMS), which may manage one or more portions of a logistical operation 200) and may refer to the date after which the particular product is no longer fit for use (e.g., consumption). Accordingly, products after their expiration date may represent a loss of value to an organization because they are no longer able to be sold. The product labeled “Painkiller 2” in FIG. 5 has an expiration date 514 of Aug. 10, 2022 and has, in this example, already expired despite having a status as “READY TO SHIP,” indicating that the product expired on the shelves. In this situation, the systems and methods for prescriptive reporting based on metadata triggers described herein would automatically generate a report based on the expired product according to one or more aspects of one or more of the methods described herein.

FIG. 6 depicts an exemplary chart 600 including quality data displayed in multiple columns including information about various products. The information includes: a product name 602, a product strength 604, a strength unit of measurement 606, a format 608, a complaint 610, a complaint date 612, and a total complaints received this period 614. The total complaints received this period 614 may refer to the total number of complaints given in a reporting period for the particular product in the same row. For example, the product “Immunosuppressive 1” received one hundred complaints in a given period as compared with other products (receiving thirty-two and thirty-four complaints, respectively). To continue with the current example of FIG. 6, the one hundred complaints in a given period (which could be any amount of time (e.g., a day, two weeks, a month, etc.) may be indicative of a quality problem with the Immunosuppressive 1 product, and hence the system could be configured to trigger an automatic report generation based on the receipt of the 100^{th} complaint in the given time period. The trigger level could be any number as determined by users of the system.

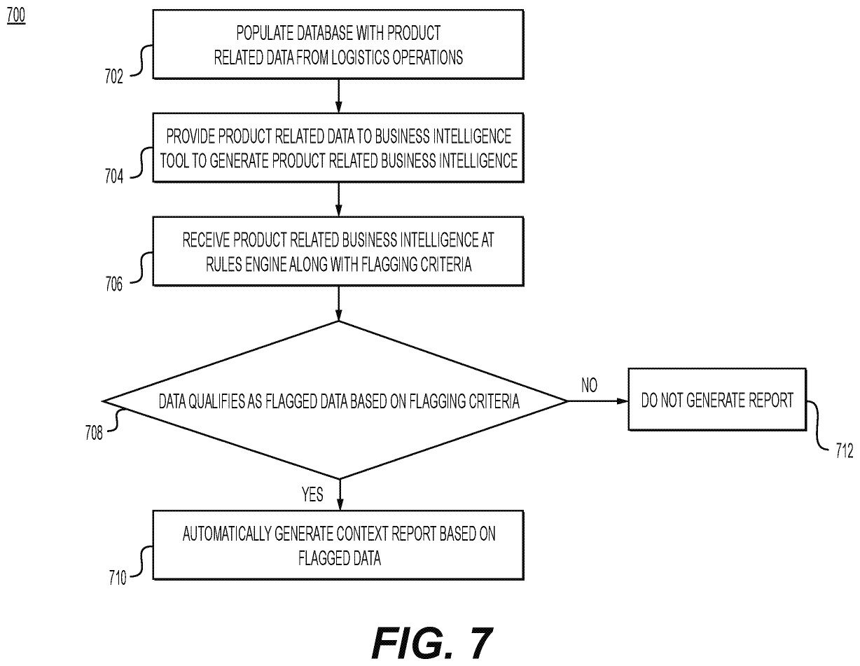

FIG. 7 depicts a method 700 of automatically generating a context report based on flagged data. It is to be understood that the method 700 for providing search results to a user shown in FIG. 7 is exemplary only and the ordinary artisan in the relevant art will recognize that additional, fewer, or alternate steps may be followed by a user and that any ensuing method would still be in keeping with the scope of the claims below.

At step 702, a database may be populated with product-related data from an organization's operations. For example, a database may be populated with data from the logistics operation depicted in FIG. 2. Data can be collected as product is created at a manufacturing site, as it is shipped from one location to another (e.g., from a manufacturing site to a warehouse, etc.), as it is stored on shelves, and during other steps in the process. The data may include, for example, data with respect to the characteristics of a product, for example, a name, a strength, a format, an expiration date, a status with respect to a supply chain step (e.g., “ready to ship”), various types of quality data (e.g., the number of times a particular product has been complained about, etc.) and other data. The database can be updated using one or more devices, for example, data may be input from devices of one or more actors within the supply chain (e.g., warehouse employees scanning a QR code on a shipment container, distributors scanning individual products, etc.), automatically (e.g., a scanner that scans product as it passes along a conveyor, etc.), or by another means of data entry. The data entered may provide context as the product makes its way through the logistics chain (e.g., for quality reports later in the logistical process, etc.)

At step 704, the product-related data may be provided to a business intelligence tool to generate product-related business intelligence (“BI”). The product-related BI may provide context regarding the circumstances surrounding the production and carrying to market (i.e., eventually reaching an end user) for the product. The BI tool may be integrated with the infrastructure of the logistics operation, for example, and may automatically connect with one or more data sources (e.g., data warehouses and databases (e.g., snowflake, Amazon Redship, Google BigQuery, etc.) and one or more data source managers to provide well organized and well presented data. The BI tool may receive the product-related data directly from the products database and my format the product-related data for presentation and/or provision to a rules engine for further processing. The BI tool(s) may be application software that may collect, collate, process, and distribute amounts of data (structured and/or unstructured) from both external and internal systems. The systems can include, for example, warehouse management systems, production line data, shipping data, health records, prescriptions, journals, images, files including documents, email, video, and other logistics and business-related sources. The BI tools may prepare and process data in expectation of analysis including report generation, for dashboards, and to be included in one or more data visualizations. The BI tool(s) may be used to increase operational efficiency, identify and understand KPIs, pinpoint new revenue potentials, and to identify other opportunities. The BI tool(s) may be used for querying and reporting of business data and can combine a broad set of analytical applications (e.g., ad hoc analysis and querying, enterprise reporting, online analytical processing (OLAP), mobile BI, real-time BI, operational BI, cloud and software as a service BI, open-source BI, collaborative BI, and location intelligence). The BI tool(s) may be configured to provide one or more visualizations via data visualization software (e.g., charts, BI dashboards, performance scorecards, etc.) displaying metrics, KPIs, and other data to increase efficiency.

At step 706, the rules engine may receive product-related BI from the BI tool which product-related BI may meet one or more flagging criteria based on previous reports stored in the reports library. For example, with reference to FIG. 5, the rules engine may receive data from the BI tool regarding a particular painkiller, in this example painkiller number 2. The drug may have a certain expiration data and in the example shown in FIG. 5, the expiration data has already passed. Accordingly, the drug has expired. Yet, the current state of the drug is a “ready to ship” state, so obviously something has occurred in this process that allowed this drug to expire on the shelves (e.g., the shelves of a warehouse). The expired state of the drug may meet flagging criteria for instance, and in this example, the system (via the rules engine) would cause one or more reports to be automatically generated. In some embodiments, the rules engine may store one or more of its rules in the rules database. In some embodiments, the incoming data may include a number of quality assurance reports generated within a given period and the flagging criteria may include a threshold number of quality assurance reports generated within the given period such that the incoming data is flagged if the number of reports generated within the given period exceeds the threshold.

At step 708, the system may query whether or not the expiration date qualifies as flagged data based on the flagging criteria. Flagged data can be flagged based on, for example, a classification of the flagged data, which classification may be related to one or more of risk assessments, quality measurements, employee training, compliance management, complaints, corrective action/preventive action (CAPA), change controls, response times, effectiveness, etc. In the current example, the flagging criteria would be met if the expiration date is before the current date and the state of the particular drug is still on the shelf in a warehouse or otherwise not distributed. For example, the status of the drug as “ready to ship” would indicate that no value has been obtained to the organization for that particular drug (e.g., it has not been sold to another organization as it is merely “ready to ship” vice “shipped”) and the expiration date having lapsed would indicate that value is unlikely to be obtained for this particular batch of product. Accordingly, the result of the query at step 708 would be that, indeed the flagging criteria is met and accordingly, the process would move on to step 710.

At step 710, a report is automatically generated which provides context to the reason behind the flagging criteria being met by the particular products in the system. The report may be provided in a predefined report format and the context may provide a reason or at least enable a user of the system to better understand the reason behind the flagged data. For example, with respect to the example shown in FIG. 5, supply chain data may be automatically pulled from the products database that shows when the painkiller 2 was shipped from its production location, how long it remained at any given location along its shipment lifecycle, when it was produced, and other data with respect to the product lifecycle. The data could include any limiting factors with respect to the product such as a failure to refrigerate the product at particular times during its lifecycle, etc. The data could be automatically generated and stored using one or more automation systems in the logistical operation 200, for example. The automatically generated report may be provided to a dashboard or other user-accessible system, which may display one or more graphical or text based reports that explain the context of why the product met flagging criteria. In some embodiments, more than one potential causes for meeting a flagging criteria may be presented and the system may be configured to determine, of the multiple potential causes, is the most likely to be the reason for meeting flagging criteria. In some embodiments, one or more solutions may be presented to preventing future instances of products meeting flagging criteria. In some embodiments, such potential solutions may be ranked, for example, based on a most cost-saving solution, most efficient solution, etc.

If there is no flagging criteria met by the various products, for example the painkiller 1 and the immunosuppressive 1 of FIG. 5 not having expired but being in a “ready to ship” state, the system would not generate a report moving on at step 712. The BI tool may be used to produce one or more other reports about the product but because it is not seen as a loss or otherwise an inefficiency, no report is automatically generated for the product.

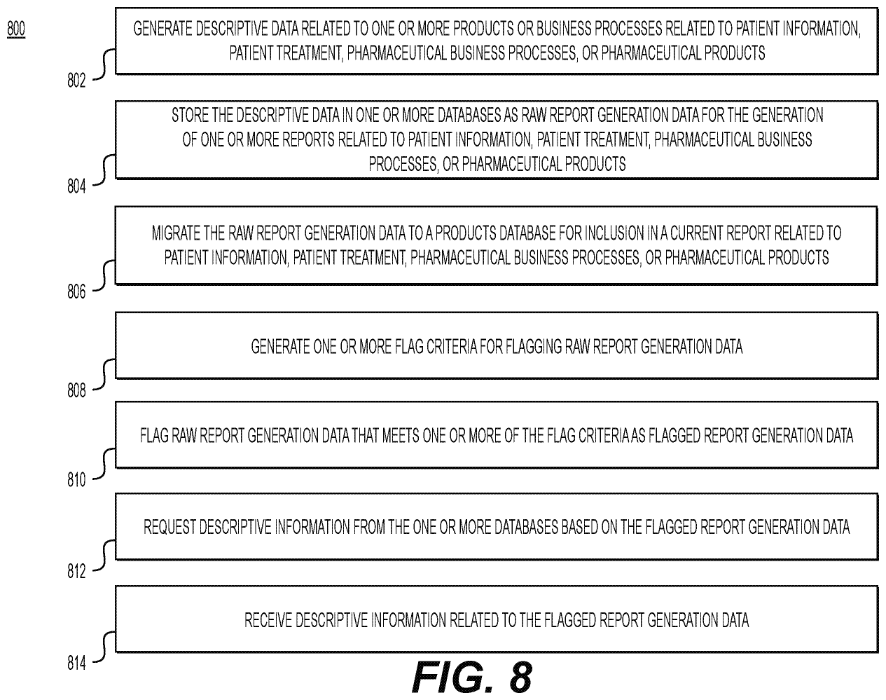

FIG. 8 depicts a method 800 of automatically generating one or more prescriptive reports based on flagged data. It is to be understood that the method 800 for providing search results to a user shown in FIG. 8 is exemplary only and the ordinary artisan in the relevant art will recognize that additional, fewer, or alternate steps may be followed by a user and that any ensuing method would still be in keeping with the scope of the claims below.

At step 802, descriptive data related to one or more products or business process may be generated. The descriptive data can come from, for example, a warehouse operation, a pharmaceutical production facility, etc. The descriptive data can be generated, for example, from customer feedback, from one or more warehouse processes, from one or more shipping operations, etc. With reference to FIG. 6 as a particular example, the descriptive data can be one or more of a name, a drug strength, a format, a number of complaints received about a particular drug, a date of a most recent complaint received, and a number of complaints received for a particular period (any period e.g., month, week, year, etc.) The descriptive data can come from one or more nodes connected to the system. For example, customer sales representatives may be given access to the system and may be responsible for generating one or more files that includes a customer complaint when a complaint is received. For example, if a customer has a complaint about a particular drug, the customer sales representative may input such complaint data into a database along with a description of the complaint, the name of the drug about which the complaint is received for, etc. This information and other information can be input to generate data and metadata associated with the operation of the organization and such descriptive data and metadata may be used to populate a database about any particular product.

At step 804, the descriptive data may be stored in one or more databases as raw report generation data for the generation of one or more reports related to patient information, patient treatment, pharmaceutical business processes, or pharmaceutical products. The descriptive data may be managed, for example, by one or more quality management systems (QMS). The QMS may provide quality management solutions to one or more regulated industries, such as the pharmaceutical industry. The QMS may be implemented as a SaaS platform, for example, and may implement one or more artificial intelligence (AI) or IoT tools to carry out one or more of its processes.

At step 806, the raw report generation data may be migrated to a products database for inclusion in a current report related to patient information, patient treatment, pharmaceutical business processes, or pharmaceutical products. The products database may be a queriable module that may interface with a business intelligence tool and may be queriable using the business intelligence tools. The data in the products database may be tuned for, for example, expected access patterns based on access of the one or more users of the database. The data in the products database may be organized for accuracy, relevancy, completeness, timeliness, and consistency. For example, the data may be profiled based on data format and data patterns, data consistency of each record, data value distributions and abnormalities, and completeness of the data. The data profiling steps may be automated in some examples. The incoming data may be checked for duplicity with other systems and duplicative data may be discarded to maintain minimal amounts of unnecessary data.

At step 808, the system may generate one or more flag criteria for flagging raw report generation data. The flag criteria can be based on data which indicates a reduction in quality of a product or a process. For example, flagging criteria could be based on a total number of quality reviews or bad ratings of a particular product having been generated such that further information can be investigated based on a relatively high number of quality reviews (e.g., above a threshold value) or a number of bad ratings of a product. In some instances, flagging criteria can be generated based on a deviation from a mean or expected value. For instance, if a date of a product shipment is expected to be within a certain number of days of a current date or a report generation date and the shipment does not occur within the expected time frame or is after the expected time frame, this might meet flagging criteria. In some embodiments, the flagging criteria is stored in a rules database. In some embodiments, the flagging criteria may be auto-generated based on data stored in a reports library, for example using machine learning and/or artificial intelligence on the reports library data. In some embodiments, the system may tag one or more metadata tags to a piece of data.

At step 810, raw report generation data that meets one or more of the flag criteria may be flagged as flagged report generation data. The raw report generation data may be flagged by the rules engine, for instance. The rules engine may automatically flag data that meets one of the flagging criteria and may generate the report automatically as described herein. In some embodiments, the raw report generation data is generated with systems connected to a QMS and stored in the reports library until it is provided to the rules engine for inclusion in an automatically generated report. As one example of raw report generation data being flagged, a drug that has expired on the shelves of a warehouse without being shipped may be sufficient to flag the generation of a report. For instance, with brief reference to FIG. 5, the painkiller 2 may have expired on the shelves while in a “ready to ship” state. Accordingly, a report could be automatically generated about this product and what factors lead to its having expired on the shelves. In some embodiments, one or more of the incoming data, the flagged data, and the context data may be stored as one or more enterprise object models in the reports library.

At step 812, the system may request descriptive information from the one or more databases based on the flagged report generation data. The descriptive information could come from, for example, the QMS and various connected information services and applications. With brief reference to FIG. 2, the QMS may generate, collect, and/or store data on the operations of the exemplary logistical operation 200. The data generated and collected using the systems and sensors described herein could be requested and used to populate the context-based reports. For example, with respect to the expired painkiller discussed above, the tracking information regarding where the painkiller was produced and originally shipped to the warehouse in which it expired could be generated and collected with the QMS and the reporting could be distilled based on the generated and collected data and at step 814, the system may receive descriptive information related to the flagged report generation data. The descriptive data could include, for example, the dates of original creation, original shipment from the origination facility (e.g., pharmaceutical laboratory, etc.) This is of course merely one example of the type of information that is capable of being produced using a system as described herein.

It should now be understood that the automation of report generation or of aspects of reports could save an organization man hours, increasing organizational efficiency. Automatic report generation may be particularly useful in, for example, a pharmaceutical context with multiple manufacturers generating scores of products in dozens of different countries because such organizations may experience great difficulty reporting on all logistical delays and other production inefficiencies. Automatically generated reports based on data contained in one or more centrally-accessible data repositories may resolve differences in reporting criteria, workflow, reporting chains, and improve the efficiencies of business structures.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A computing system comprising:
a processor configured for executing one or more processes based on machine-readable instructions; and
a memory storing one or more machine readable instructions, including a rules engine, that when executed by the processor cause the computing system to:
receive incoming data related to one or more quality assurance business processes;
analyze the incoming data to determine data meeting flagging criteria for flagging the incoming data as flagged data, wherein the data meeting flagging criteria indicates that additional context is necessary with respect to the flagged data the incoming data includes a number of quality assurance reports generated within a given period and the flagging criteria includes a threshold number of quality assurance reports generated within the given period such that the incoming data is flagged if the number of reports generated within the given period exceeds the threshold; and
automatically generate a context report based on the flagged data, wherein the context report includes, at least, the flagged data and context data that indicates specific flagging criteria of the flagged data.

2. The computing system of claim 1, wherein the flagged data and the context data are provided to a user in a predefined report format.

3. The computing system of claim 2, wherein the predefined report format is stored in a reports library.

4. The computing system of claim 1, wherein one or more of the incoming data, the flagged data, and the context data are stored as one or more enterprise object models.

5. The computing system of claim 1, wherein the flagging criteria includes a pharmaceutical expiration data.

6. The computing system of claim 1, wherein the given period is one year or less.

7. The computing system of claim 1, wherein the flagged data is classified based on one or more sectors of a business to which the flagged data relates and the context data that is received is based on a classification of the flagged data.

8. The computing system of claim 7, wherein the classification of the flagged data is related to one or more of risk assessments, quality measurements, employee training, compliance management, complaints, corrective action/preventive action (CAPA), change controls, response times, and effectiveness.

9. The computing system of claim 1, wherein the flagging criteria includes one or more metadata tags for tagging received data.

10. The computing system of claim 9, wherein the one or more metadata tags are object based metadata tags.

11. A method of receiving descriptive data that describes raw report generation data based on information about the raw report generation data, the method comprising:
generating descriptive data related to one or more products or business processes related to patient information, patient treatment, pharmaceutical business processes, or pharmaceutical products;
storing the descriptive data in one or more databases as raw report generation data for the generation of one or more reports related to patient information, patient treatment, pharmaceutical business processes, or pharmaceutical products;
migrating the raw report generation data to a products database for inclusion in a current report related to patient information, patient treatment, pharmaceutical business processes, or pharmaceutical products;
generating one or more flag criteria for flagging raw report generation data;
flagging raw report generation data that meets one or more of the flag criteria as flagged report generation data;
requesting descriptive information from the one or more databases based on the flagged report generation data; and
receiving descriptive information related to the flagged report generation data.

12. The method of claim 11, wherein raw report generation data that meets one or more of the flag criteria is automatically flagged as flagged report generation data each time raw report generation data is migrated to the products database.

13. The method of claim 11, wherein the descriptive information is requested from the one or more databases based on a classification of the flagged report generation data.

14. The method of claim 13, wherein the classification of the flagged report generation data includes classification of the data as related to one or more of risk assessments, quality measurements, employee training, compliance management, complaints, corrective action/preventive action (CAPA), change controls, response times, and effectiveness.

15. The method of claim 11, wherein the received descriptive information related to the flagged report generation data is compiled into a report for presentation to a user.

16. The method of claim 15, wherein the user can only access the compiled report based on a permission level of the user.

17. The method of claim 15, wherein the user can only distribute the compiled report based on a permission level of the user.

18. A method of automatically generating one or more business intelligence reports, the method comprising:
migrating raw report generation data from one or more databases storing descriptive data to a products database for inclusion in a current report related to patient information, patient treatment, pharmaceutical business processes, or pharmaceutical products;
generating one or more flag criteria for flagging raw report generation data;
flagging raw report generation data that meets one or more of the flag criteria as flagged report generation data;
requesting descriptive information from the one or more databases based on the flagged report generation data;
receiving descriptive information related to the flagged report generation data; and
compiling the received descriptive information related to the flagged report generation data into a report for presentation to a user in a form of a prescriptive report.

19. The method of claim 18, wherein the raw report generation data is flagged based on one or more metadata tags associated with the raw report generation data.

20. The method of claim 18, wherein the received descriptive information is compiled into a report format based on a user profile of the user requesting the business intelligence report.
